(19) United States
(12) Patent Application Publication
(10) Pub. No.: US 2015/0234595 A1
(43) Pub. Date: Aug. 20, 2015

(54) STORAGE DEVICE

(71) Applicant: KABUSHIKI KAISHA TOSHIBA, Tokyo (JP)

(72) Inventor: Masafumi Satou, Inagi-shi (JP)

(73) Assignee: KABUSHIKI KAISHA TOSHIBA, Tokyo (JP)

(21) Appl. No.: 14/266,170

(22) Filed: Apr. 30, 2014

Related U.S. Application Data
(60) Provisional application No. 61/940,061, filed on Feb. 14, 2014.

(51) Int. Cl. G06F 3/06

(52) U.S. Cl. CPC G06F 3/061; G06F 3/0676; G06F 3/0659

(57) ABSTRACT

According to one embodiment, a storage device includes a magnetic disk, a semiconductor memory, and an interface to a host device. The interface is configured to process address information from the host device as address information on the magnetic disk or address information on the semiconductor memory.

### CROSS-REFERENCE TO RELATED APPLICATIONS

This application claims the benefit of U.S. Provisional Application No. 61/940,061, filed Feb. 14, 2014, the entire contents of which are incorporated herein by reference.

### FIELD

Embodiments described herein relate generally to a storage device.

### BACKGROUND

In recent years, semiconductor hybrid drives (SSHDs) have been developed in each of which a semiconductor memory is mounted on a hard disk drive (HDD) provided with a magnetic disk. The semiconductor memory has a high speed and a middle or small capacity, and is expensive per bit, as compared with the magnetic disk. As the semiconductor memory, for example, a NAND type flash memory (hereinafter referred to as a NAND memory) is used.

It is expected that a performance of a storage device is improved by applying a NAND memory as a data cache in an SSHD. For example, the storage device analyzes an access pattern of a logical block address (LBA) from a high-order control device (host device) by itself, learns it, and copies frequently-accessed data to the NAND memory, to thereby improve a hit rate of cache data in the SSHD.

However, for example, in storage devices applied to the enterprise market, since a variety of applications are operated, an access pattern of LBA cannot be properly analyzed or learned, and it is not necessarily ensured that expected performance of the storage devices can be obtained.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an example of a configuration of a system using a storage device according to an embodiment.

FIG. 2 is a block diagram showing an example of a configuration of the storage device according to the embodiment.

FIG. 3 shows an example of a Read/Write command of an SCSI.

FIG. 4 shows an example of a Read/Write operation in accordance with the Read/Write command shown in FIG. 3.

FIGS. 5A and 5B show an example of allocation of LBAs in the embodiment.

FIG. 6 shows an example of a command to allocate LBAs.

FIG. 7A shows an example of a header following the command shown in FIG. 6.

FIG. 7B shows an example of Block Descriptor following the header shown in FIG. 7A.

FIG. 7C shows an example of Page Descriptor following Block Description shown in FIG. 7B.

FIG. 8 shows an example of allocation of LBAs for a DRAM and a NAND memory.

FIG. 9 shows an example of specification of address spaces in the embodiment.

FIGS. 10A and 10B show an example of double-layering of storage device.

FIGS. 11A and 11B show an example of three-layering of storage device.

FIGS. 12A and 12B show an example of setting of address spaces.

### DETAILED DESCRIPTION

Various embodiments will be described hereinafter with reference to the accompanying drawings.

In general, according to one embodiment, a storage device includes a magnetic disk, a semiconductor memory used as a cache for the magnetic disk, and an interface to a host device. The interface is configured to process address information from the host device, as address information on the magnetic disk or that on the semiconductor memory.

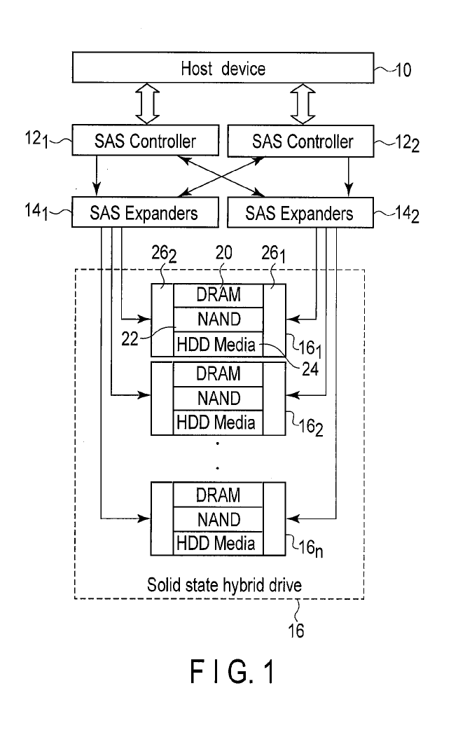

FIG. 1 is a block diagram showing an example of a configuration of a system using a storage device according to an embodiment. The system includes a plurality of SSHDs 16₁-16ₙ as external storage devices. An SSHD 16 includes three kinds of storage media, i.e., a DRAM (RAM disk) 20, a NAND memory 22, a magnetic disk (HDD media) 24. The capacity, speed and price of the DRAM 20 are small, high and high, respectively, and the DRAM 20 is used as a primary cache memory of the magnetic disk 24. The capacity, speed and price of the NAND memory 22 are intermediate between those of the DRAM 20 and those of the magnetic disk 24, and the NAND memory 22 is used as a secondary cache memory of the magnetic disk 24. For example, the DRAM 20 has a capacity of several tens of megabytes; the NAND memory 22 has a capacity of several tens of gigabytes; and the magnetic disk 24 has a capacity of approximately several hundreds of gigabytes. The SSHD 16 is of a dual port type, and includes two interfaces 26₁ and 26₂. The interfaces 26₁ and 26₂ of each of the SSHD 16₁, 16₂, . . . 16ₙ are connected to Serial Attached SCSI (SAS) Expanders 14₁ and 14₂, respectively. The host device 10 is connected to both SAS

Controllers 12₁ and 12₂. Each of the SAS Controllers 12₁ and 12₂ is connected to both the SAS Expanders 14₁ and 14₂. This structure enables the SSHD 16 to perform a dual port operation.

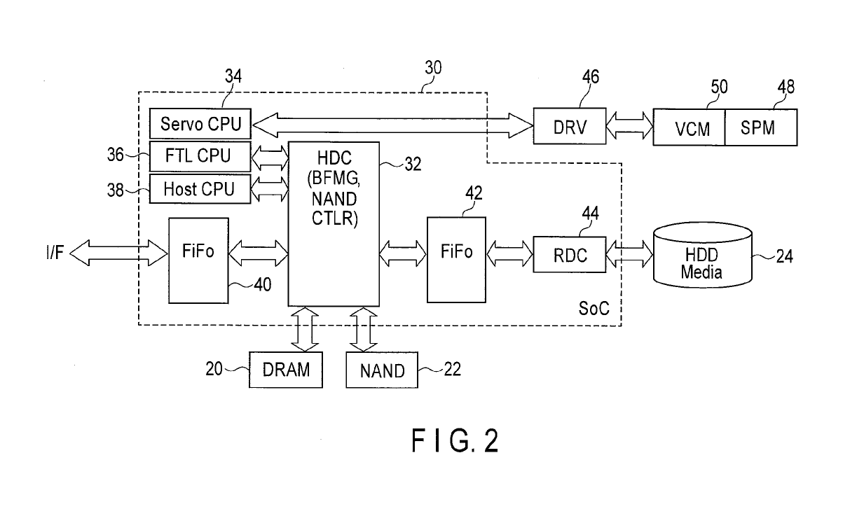

FIG. 2 is a block diagram showing an example of a configuration of the SSHD 16. The SSHD 16 includes a System on a Chip (SoC) 30 which controls the following three kinds of storage media: the DRAM 20; the NAND memory 22; and the magnetic disk 24. The SoC 30 includes the following three kinds of CPUs: a servo CPU 34; a flash translation layer (FTL) CPU 36; and a host CPU 38. The FTL CPU 36 and the host CPU 38 are connected to a hard disk controller (HDC) 32. The HDC 32 includes a buffer manager and a NAND controller. Also, the HDC 32 is connected to the DRAM 20, the NAND memory 22 and FIFO memories 40 and 42. The FIFO memory 40 is connected between the HDC 32 and the SAS Expanders 14₁ and 14₂. The FIFO memory 42 is connected between an RDC 44 and the HDC 32, and the RDC 44 accesses the magnetic disk 24. The servo CPU 34 controls a voice call motor (VCM) 50 and a spindle motor (SPM) 48 with a DRV 46.

In the embodiment, an HDD corresponding to a conventional external storage device is replaced with a storage device including two or more kinds of storage media including at least one semiconductor memory such as a DRAM or a NAND memory. The host device is made to enable the two or more kinds of storage media to be independently subjected to writing/reading. Therefore, it is possible to achieve layering of an external storage device incorporating the two or more kinds of storage media. In the embodiment, although an interface module is provided in common for the two or more kinds of storage media, address spaces of the magnetic disk 24, the NAND memory 22 and the DRAM 20 provided in the inside are controlled as separate address spaces, as a result of which independent write/read commands can be given to the two or more kinds of storage media, respectively. For example, in a conventional SSHD, a NAND memory is used an internal cache for an HDD, whereas in the embodiment, the NAND memory 22 is open to the host device, and can be used as a cache of a system by the host device.

Furthermore, it is possible to achieve layering suitable for a pattern of a file access from the host device or a system cache with respect to an application level. It is also possible to make arbitrary part of space (HDD space) of the magnetic disk 24 double as space of the NAND memory 22 and that of the DRAM 20.

In a conventional layering system, an SSD allowed to be accessed at a high speed and an HDD having a large capacity and produced at a low cost are connected in combination with a host device; and frequently-accessed data is written to the SSD, and data required to be finally stored is written to the HDD, thereby improving the performance of the entire system. However, for both the HDD and the SSD, it is necessary to provide respective mounting slots. Also, the host device needs to read out original data from the HDD, and write the data to the SSD. In addition, in the case where it is also necessary to store data from the SSD in the HDD, the host device needs to read out the data from the SSD, and then write it to the HDD. On the other hand, in the embodiment, since the interface module is used as a common one, it suffices to provide a mounting slot for the SSHD only, the magnetic disk 24, the NAND memory 22 and the DRAM 20 can be independently given a Write/Read command, and data can also be transferred from the magnetic disk 24 to the DRAM 20 and the NAND memory 22 without the need to transfer it through the host device.

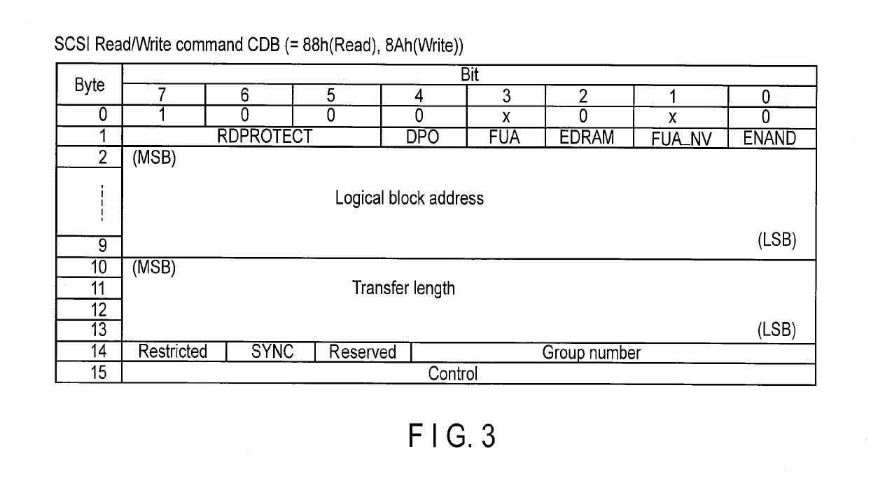

FIG. 3 shows an example of a command from the host device 10 to directly access the media in the SSHD 16, i.e., the DRAM 20, the NAND memory 22 and the magnetic disk (HDD media) 24, in order to achieve layering. FIG. 3 shows an example of a Read/Write command in the embodiment, which is based on a Read/Write command (which is a Read command whose command code of bits 0 to 7 of byte 0 is 88 h, or a Write command whose command code is 8Ah) of a small computer system interface (SCSI). Reserved Bits of a Command Description Block (CDB) for Read/Write in the SCSI are used. To be more specific, three Reserved Bits: bit 0 of byte 1; bit 2 of byte 1; and bit 6 of byte 14, are used. To bit 0 of byte 1, ENAND (Enable NAND Address) is written; to bit 2 of byte 1, EDRAM (Enable DRAM Address) is written, and to bit 6 of byte 14, SYNC is written.

The EDRAM (=“1”) indicates that an address space specified by LOGICAL BLOCK ADDRESS (LBA) written to bytes 2 to 9 and TRANSFER LENGTH written to bytes 10 to 13 is an address space of the DRAM 20, and an R/W operation is a data transfer between the DRAM 20 and the host device 10 in the SSHD 16. The ENAND (=“1”) indicates that an address space specified by LOGICAL BLOCK ADDRESS written to bytes 2 to 9 and TRANSFER LENGTH written to bytes 10 to 13 is an address space of the NAND memory 22, and an R/W operation is a data transfer between the NAND memory 22 and the host device 10 in the SSHD 16. SYNC (=“1”) indicates that the magnetic disk (HDD Media) 24 and the DRAM 20 or the NAND memory 22 are synchronized with each other.

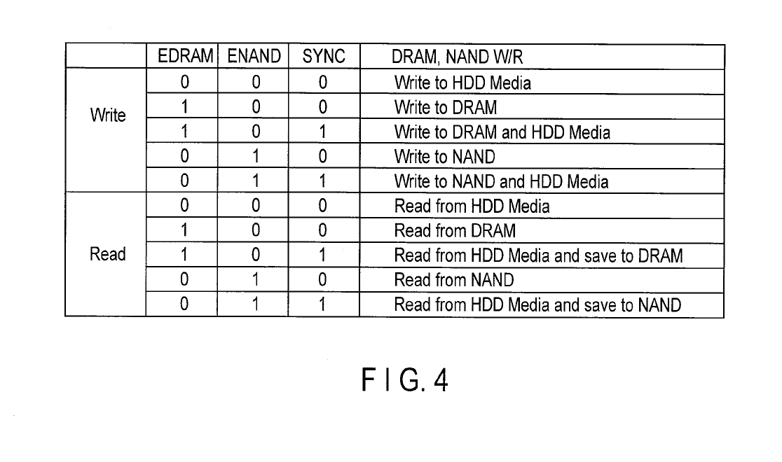

FIG. 4 shows an example of a Read/Write operation to be performed in response to the Read/Write command shown in FIG. 3, which varies in accordance with variation of a combination of values of ENAND, EDRAM and SYNC.

In the Write command, if EDRAM, ENAND and SYNC are all “0”, it means ordinary writing to the magnetic disk (HDD Media) 24. If EDRAM is “1”, and ENAND and SYNC are “0”, it means writing to the DRAM 20. If EDRAM and SYNC are “1”, and ENAND is “0”, it means writing to both the DRAM 20 and the magnetic disk (HDD Media) 24. If ENAND is “1”, and EDRAM and SYNC are “0”, it means writing to the NAND memory 22. If ENAND and SYNC are “1”, and EDRAM is “0”, it means writing to both the NAND memory 22 and the magnetic disk (HDD Media) 24.

In the Read command, if EDRAM, ENAND and SYNC are all “0”, it means ordinary reading from the magnetic disk (HDD Media) 24. If EDRAM is “1”, and ENAND and SYNC are “0”, it means reading from the DRAM 20. If EDRAM and SYNC are “1”, and ENAND is “0”, it means that data is read from the magnetic disk (HDD Media) 24, and then saved in the DRAM 20. If ENAND is “1”, and EDRAM and SYNC are “0”, it means reading from the NAND memory 22. If ENAND and SYNC are “1”, and EDRAM is “0”, it means that data is read out from the magnetic disk (HDD Media) 24, and then saved in the NAND memory 22.

In such a manner, “0” and “1” are written in combination to the three bits of the Read/Write command, to thereby allow the host device 10 to directly access to any of media (the DRAM 20, the NAND memory 22 and the magnetic disk (HDD Media) 24) in the SSHD 16. By virtue of this structure, for example, the host device 10 can use the SSD (NAND memory) 22 in the SSHD 16 as a secondary cache in the system or the DRAM 20 in the SSHD 16 as a primary cache in the system.

Next, it will be explained by way of example that address spaces are allocated to a plurality of kinds of storage media in accordance with characteristics thereof to improve the performance and efficiency of the entire system. A layered storage system is present in which a plurality of storage devices such as an HDD, a solid-state drive (SSD) and a RAM disk are mounted, and are layered in accordance with their performance. In the layered storage system, storage of data is allocated to any of the plurality of kinds of storage media such that frequently-accessed data is stored in a high-speed storage media (a DRAM disk, an SSD or the like), and infrequently-accessed data is stored in a low-speed storage medium (an HDD or the like). In the embodiment, there are provided two or more kinds of storage media including a semiconductor memory such as the NAND memory, and the two or more kinds of storage media can be independently subjected to writing/reading by the host device. Thus, in certain files peculiar to the system, data in a magnetic disk space (HDD space) is copied to an area of the DRAM or NAND memory in advance, thus enabling the performance and efficiency of the entire system to be improved. For example, a system boot file stored in the magnetic disk space (HDD space) is copied to the area of the NAND memory before the system is powered up, as a result of which system boot processing after powering up the system can be executed at a higher speed. Conventionally, when a system is powered up, in order to read out a boot file from an HDD, seek and rotational latency are necessary after a motor is revolved and the number of revolutions of a motor reaches a predetermined number. Thus, it takes a dozen or so seconds. However, if a boot file is copied to the NAND in advance, boot can be effected in a few seconds.

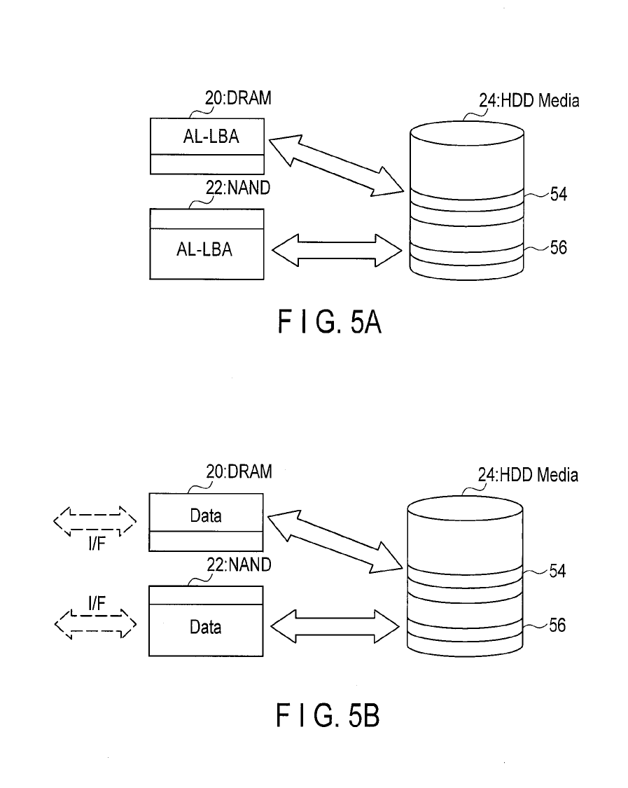

It will be explained to which of areas (the DRAM, NAND memory and magnetic disk) in the SSHD each of data is allocated and copied. Since the host device 10 recognizes which files are stored in areas of the magnetic disk (HDD Media) 24, and to which areas the files are stored, at an initial setup time of the system, a system boot file, a reboot file, an application startup file, etc. may be copied to the DRAM 20 or the NAND memory 22. As shown in FIG. 5A, address spaces 54 and 56 of the magnetic disk (HDD Media) 24 are allocated to address spaces of the DRAM 20 and the NAND memory 22, respectively. Then, as shown in FIG. 5B, data in the address space 54 and that in the address space 56 are copied to the address space of the DRAM 20 and that of NAND memory 22, respectively. By virtue of this feature, thereafter, when a command to read out the above data is given by the host device 10, the data is directly transferred from the DRAM 20 and the NAND memory 22 to the host device 10, thereby improving the performance of the entire system.

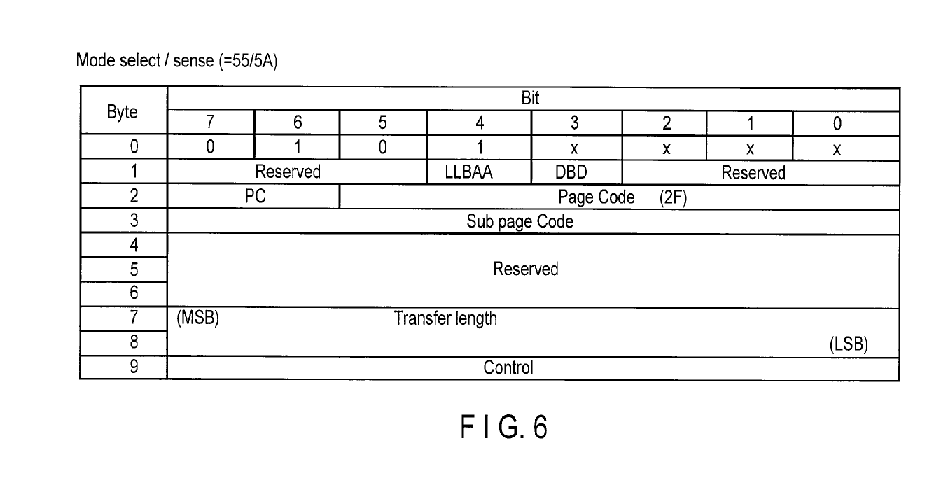

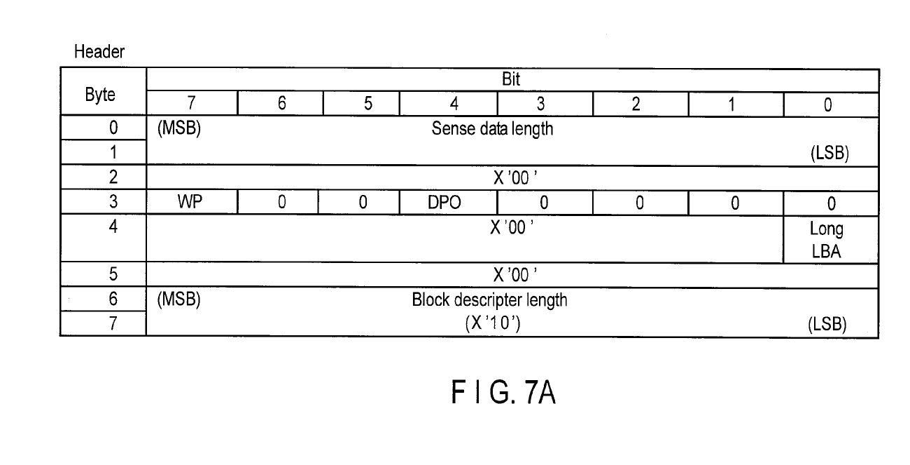

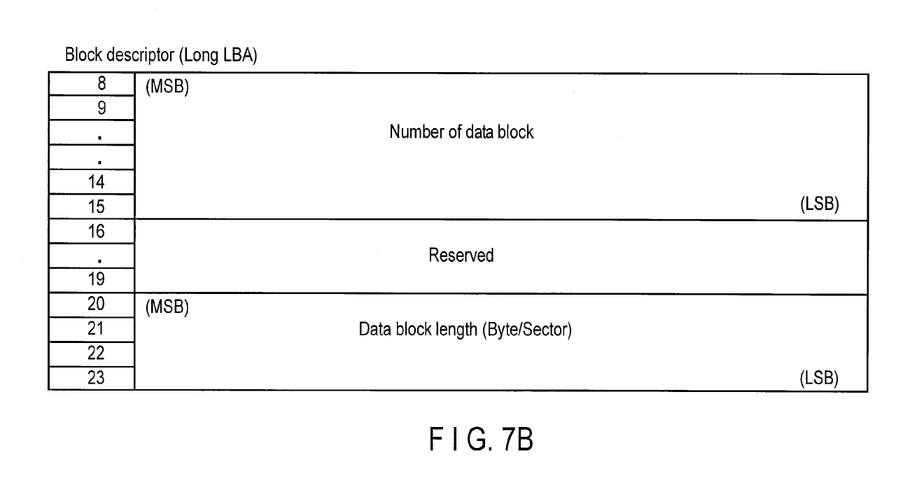

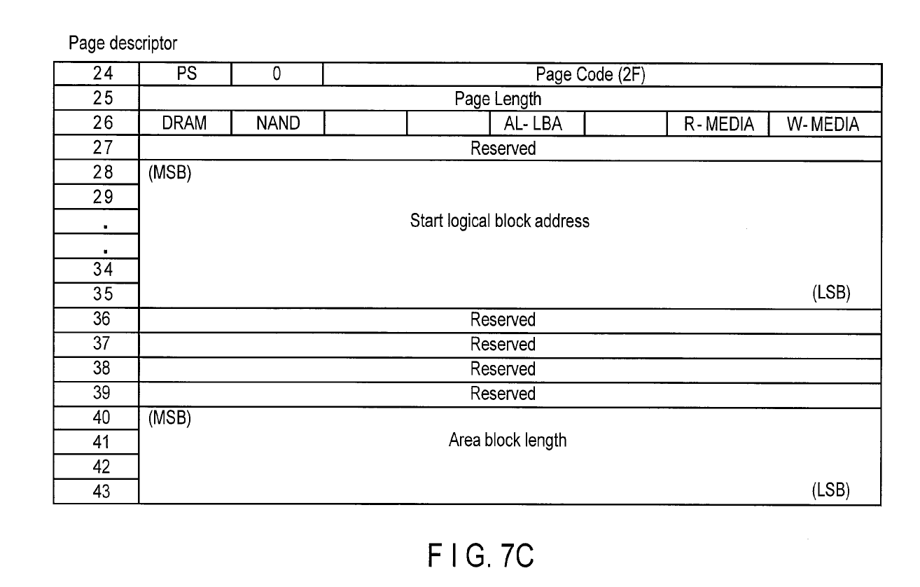

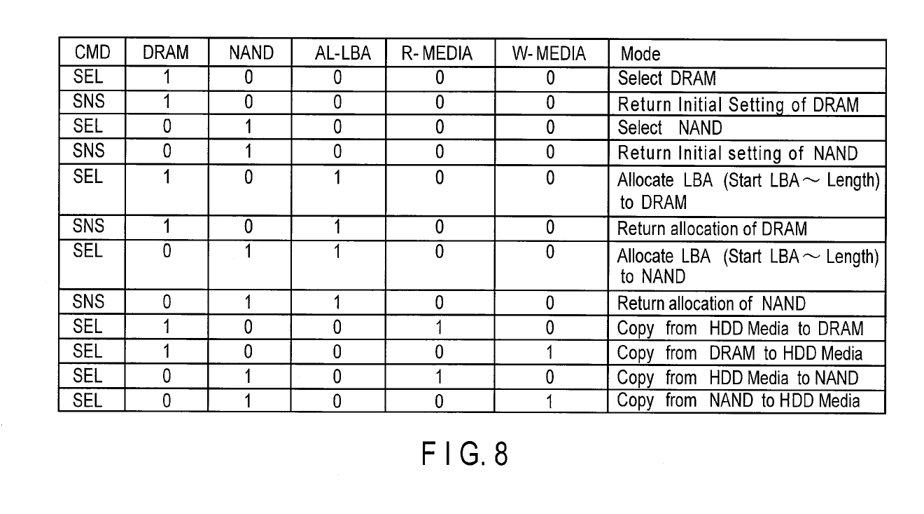

An example of a command to achieve recognition of capacities in each of the storage media of the SSHD 16 and allocation of areas to the spaces of the storage media will be explained. FIG. 6 shows an example of a command in the embodiment, which is based on a ModeSelect (whose command code is 55 h)/ModeSense (whose command code is 5Ah) command of the SCSI. 2Fh is set to Page Code (reserved) written to bits 0 to 5 of byte 2. In the case where 2Fh is written to the Page Code, it is possible to set/confirm predetermined data which follows the ModeSelect/ModeSense command. Header, Block Descriptor (Long LBA) and Page Descriptor which are shown in FIGS. 7A, 7B and 7C, respectively, follows the ModeSelect/ModeSense command. The Header, Block Descriptor and Page Descriptor are handled as a single CDB. To be more specific, bytes 0-7 correspond to the Header, bytes 8-23 correspond to the Block Descriptor and the bytes 24-43 correspond to the Page Descriptor. Also, to the Page Descriptor, bits 0 to 5 of byte 24, Page Code is written. Also, to the Page Code, 2Fh is set. An operation as shown in FIG. 8 is specified in accordance with the values of W-MEDIA (write media) of bit 0, R-MEDIA (read media) of bit 1, AL-LBA (allocate LBA) of bit 3, NAND of bit 6 and DRAM of bit 7 of byte 26 in the Page Descriptor. Space to be allocated is specified by Start Logical Block Address written to bytes 28-35 and Area Block Length written to bytes 40-43.

To be more specific, with respect to the ModeSelect command (SEL), if the DRAM is “1”, and the NAND, the AL-LBA, the R-MEDIA and the W-MEDIA are “0”, it means selection of the DRAM 20. If the NAND is “1”, and the DRAM, the AL-LBA, the R-MEDIA and the W-MEDIA are “0”, it means selection of the NAND memory 22. If the DRAM and the AL-LBA are “1”, and the NAND, the R-MEDIA and the W-MEDIA are “0”, it means that a specified LBA (an LBA specified by Start Logical Block Address and Length) in the magnetic disk (HDD Media) 24 is allocated to the DRAM 20. If the NAND and the AL-LBA are “1”, and the DRAM, the R-MEDIA and the W-MEDIA are “0”, the specified LBA in the magnetic disk (HDD Media) 24 is allocated to the NAND memory 22. If the DRAM and the R-MEDIA are “1”, and the NAND, the AL-LBA and the W-MEDIA are “0”, it means that data of the specified LBA in the magnetic disk (HDD Media) 24 is copied to the DRAM 20. If the DRAM and the W-MEDIA are “1”, and the NAND, the AL-LBA and the R-MEDIA are “0”, it means that data of a specified LBA in the DRAM 20 is copied to the magnetic disk (HDD Media) 24. If the NAND and the R-MEDIA are “1”, and the DRAM, the AL-LBA and the W-MEDIA are “0”, it means that the data of the specified LBA in the magnetic disk (HDD Media) 24 is copied to the NAND memory 22. If the NAND and the W-MEDIA are “1”, and the DRAM, the AL-LBA and the R-MEDIA are “0”, it means that data of a specified LBA in the NAND memory 22 is copied to the magnetic disk (HDD Media) 24.

With respect to the ModeSense command (SNS), if the DRAM is “1”, and the NAND, the AL-LBA, the R-MEDIA and the W-MEDIA are “0”, it means that an initial set value (an address state set before) of the DRAM 20 is reported to the host device 10. If the NAND is “1”, and the DRAM, the AL-LBA, the R-MEDIA and the W-MEDIA are “0”, it means that the initial set value of the NAND memory 22 is reported. If the DRAM and the AL-LBA are “1”, and the NAND, the R-MEDIA and the W-MEDIA are “0”, it means that a result of allocation to the DRAM 20 is reported. If the NAND and the AL-LBA are “1”, and the DRAM, the R-MEDIA and the W-MEDIA are “0”, it means that a result of allocation to the NAND memory 22 is reported.

By virtue of the above feature, an LBA is allocated and data is copied, from the magnetic disk (HDD Media) 24 to the NAND memory 22 without the need to perform allocation and copying through the host device 10.

The following are two examples of the case where in order that address spaces of two or more kinds of storage media (a magnetic disk, a NAND memory and a DRAM) including at least one semiconductor memory such as a DRAM or NAND memory, which are provided in an SSHD, be independently controlled by the host device, and the storage media of such a single SSHD be dividedly managed, the storage media are identified, and address spaces are specified.

In the first one of the two examples, the storage media are identified with unused ones of bytes specifying the LBA of CDB for Read/Write in the SCSI, for example, with the most significant bytes. To be more specific, the magnetic disk (HDD Media) 24 has 1 TB, the NAND memory 22 has 32 GB, and the DRAM 20 has 128 MB. An LBA specifying the magnetic disk (HDD Media) 24 is 0x0000 0000 0000 0000 to 0x0000 0000 7FFF FFFF. An LBA specifying the NAND memory 22 is 0x8000 0000 0000 0000 to 0x8000 0000 03FF FFFF. An LBA specifying the DRAM 20 is 0x4000 0000 0000 0000 to 0x4000 0000 0003 FFFF. The above underlined most significant bytes “0”, “8” and “4” are identifiers for the magnetic disk (HDD Media) 24, the NAND memory 22a and the DRAM 20. Thereby, the host device 10 can specify the address spaces of the magnetic disk (HDD Media) 24, NAND memory 22 and DRAM 20, and easily identify the storage media in the SSHD. It should be noted that an identifier is not limited to the most significant byte, and any of the bytes specifying an LBA may be applied as the identifier as long as it is unused.

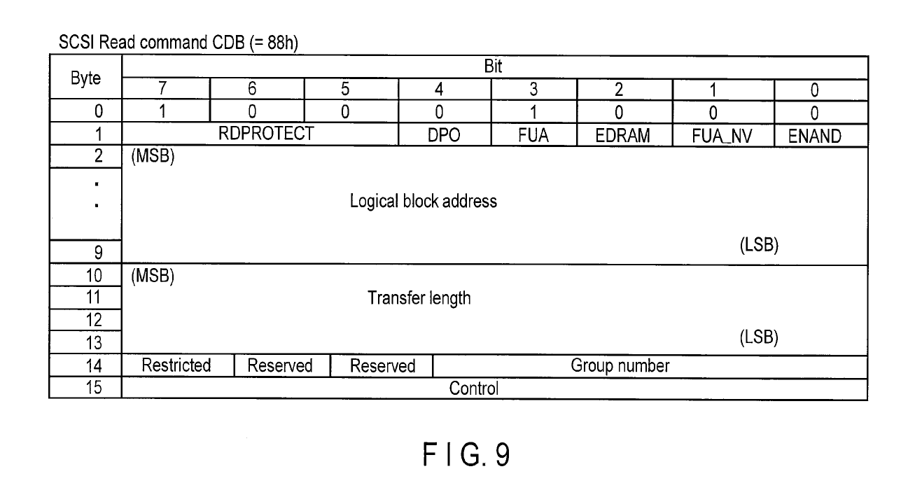

In the second example, the Read/Write command of the SCSI is used. FIG. 9 shows an example of a Read/Write command in the embodiment, which is based on the Read/Write command in the SCSI. In this example, two Reserved Bits of the CDB for Read/Write in the SCSI; i.e., bit 0 of byte 1 and bit 2 of byte 1 are used. To bit 0 of byte 1, ENAND is written, and to bit 2 of byte 1, EDRAM is written. This is the same as the example shown in FIG. 3 in which SYNC in the Read/Write command is maintained as a Reserved Bit.

If EDRAM is “1”, and ENAND is “0”, as shown in FIG. 3, it means that the address space specified by LOGICAL BLOCK ADDRESS and TRANSFER LENGTH is the address space of the DRAM 20, and the R/W operation is a data transfer between the DRAM 20 in the SSHD 16 and the host device 10. If ENAND is “1”, and EDRAM is “0”, it means that the address space specified by LOGICAL BLOCK ADDRESS and TRANSFER LENGTH is the address space of the NAND memory 22, and the R/W operation is a data transfer between the NAND memory 22 in the SSHD 16 and the host device 10. If EDRAM and ENAND are both “0”, it means that the address space specified by LOGICAL BLOCK ADDRESS and TRANSFER LENGTH is the address space of the magnetic disk (HDD Media) 24, and the R/W operation is a data transfer between the magnetic disk (HDD Media) 24 in the SSHD 16 and the host device 10.

In such a manner, the address spaces of the DRAM and the NAND memory can be easily specified by EDRAM and ENAND.

Although it is not shown, CDBs for Read/Write may be produced specifically for the NAND memory and the DRAM.

Next, an example of a layering system using the SSHD according to the embodiment will be explained. As described above, the embodiment relates to a storage device including two or more kinds of storage media including at least one semiconductor memory such as a DRAM or a NAND memory, and enables the two or more kinds of storage media to be directly accessed. Thus, it has functions of a plurality of storage devices, which are associated with the storage media. Although the DRAM is inferior in data assurance at the time of power-down as it is volatile, it has a function of a RAM disk which can carry out a high-speed access/data transfer. The NAND memory ensures data assurance at the time of power-down as it is nonvolatile, but it is slightly inferior in reliability in long-term usage. However, it has a function of an SSD which can carry out a high-speed access/data transfer to some extent. An HDD provided with a magnetic disk is at a very high level in reliability and data assurance at the time of power-down, and thus in the mainstreams of storage devices; however, it is slow in access/data transfer. By combining such a plurality of storage devices as described above, a layered system can be made. Also, a system having a high performance/reliability can be established/managed by properly selective use of individually provided storage devices by the host device.

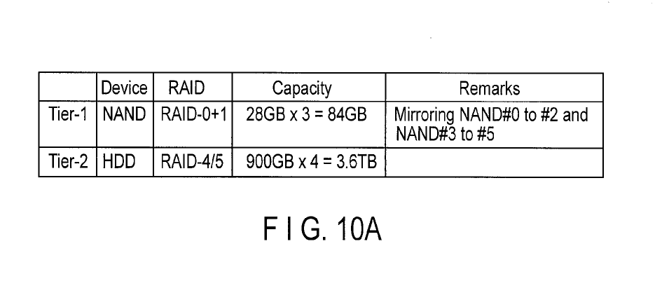

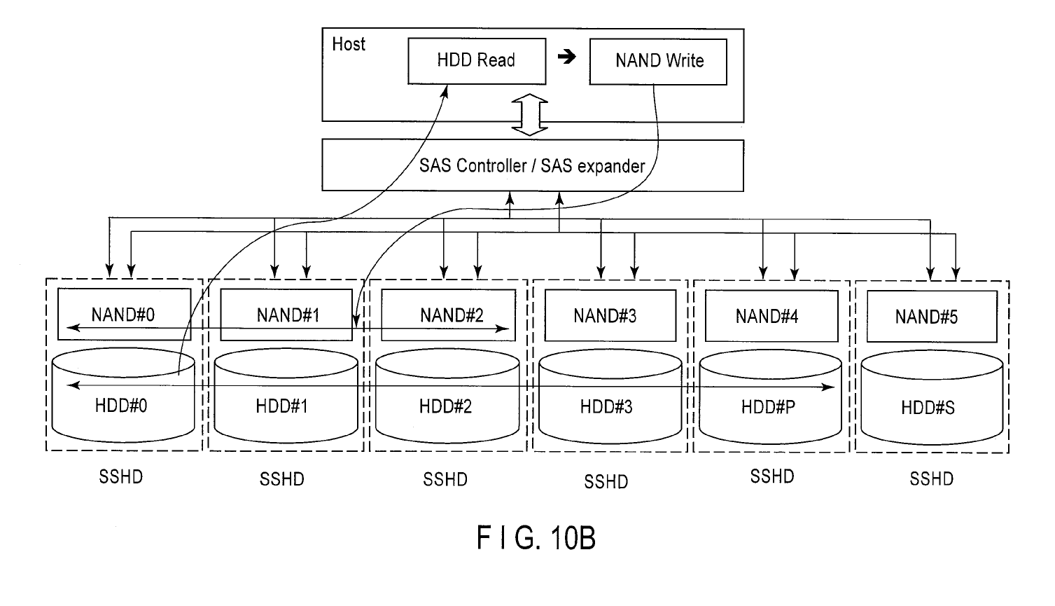

First of all, an example of a combination of two tiers of a NAND memory (SSD) and a magnetic disk (HDD) will be explained, where a DRAM is omitted. FIGS. 10A and 10B show an example of a layered system made of six SSHDs. A tier 1 is formed of an NAND memory (SSD), and its RAID level is RAID 0+1. A tier 2 is formed of a magnetic disk (HDD), and its RAID level is RAID 4 or RAID 5. An SSHD includes a NAND memory (SSD) having 28 GB and a magnetic disk (HDD) having 900 GB. In order to effect mirroring, NAND #0 to NAND #2 and NAND #3 to NAND #5 are duplexed, and thus the total capacity of the NAND memories is 28×3=84 GB. The RAID levels of the magnetic disks (HDDs) are RAID 4 or RAID 5. Thus, a magnetic disk for parity and a magnetic disk for spare are provided. Therefore, the total capacity of the HDDs is 900×4=3.6 TB. Although only one SAS controller and one SAS expander are shown in FIG. 10B in order to simplify an explanation, actually, two SAS controllers and two SAS expanders are provided as in FIG. 1.

The host device 10 reads out data from the HDD #0 to HDD #P, subjects the data to some processing, and then writes the data to the NAND #0 to NAND #2 and the NAND #3 to NAND #5 at a high speed. Thereafter, by also writing the above data subjected to the processing to the HDD #0 to HDD #P, a two-layered system of NANDs and HDDs is achieved.

Also, the host device 10 may copy data of a magnetic disk (HDD) of a given SSHD to a NAND memory of another SSHD.

Furthermore, the host device 10 may copy data read from magnetic disks (HDDs) of arbitrary ones of the SSHDs to NAND memories of arbitrary ones of the SSHDs.

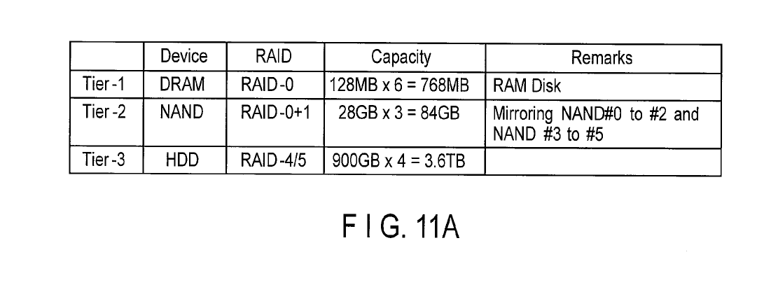

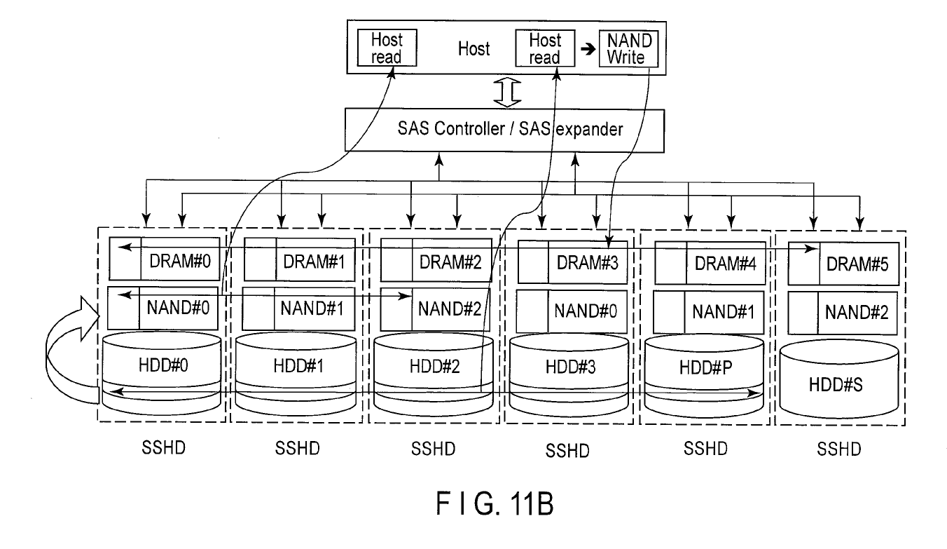

Next, an example of three tiers which are a DRAM (RAM disk), a NAND memory (SSD) and a magnetic disk (HDD) will be explained with reference to FIGS. 11A and 11B. To be more specific, a tier 1 is made of a DRAM, and its RAID level is RAID 0. A tier 2 is made of a NAND memory, and its RAID level is RAID 0+1. A tier 3 is made of a magnetic disk (HDD), and its RAID level is RAID 4 or RAID 5. An SSHD includes a DRAM having 128 MB, a NAND memory having 28 GB and an HDD having 900 GB. The total capacity of DRAMs is 128×6=768 MB. In order to effect mirroring, NAND #0 to NAND #2 are duplexed with NAND #3 to NAND #5. Thus, the total capacity of NANDs is 28×3=84 GB. The RAID levels of the HDDs are RAID 4 or RAID 5. Thus, an HDD for parity and an HDD for spare are provided. Therefore, the total capacity of the HDDs is 900×4=3.6 TB.

In a layered system shown in FIGS. 10B and 11B, by a method shown in FIGS. 6 to 8, a specified area in the magnetic disk (HDD) (e.g., a storage area of a system boot file) is allocated to the NAND memory, and data of the specific area is copied to the NAND memory. Then, the host device 10 reads out data from the NAND memory at a high speed. Thus, a system boot, etc. can be achieved at a high speed. It should be noted that the above is not limited to the system boot file, and arbitrary data may be copied from the magnetic disk (HDD) to the NAND memory.

In the case where a system boot file or an arbitrary data is copied from the magnetic disk (HDD) to the NAND memory, the host device 10 may also copy data of a magnetic disk (HDD) of a given SSHD to a NAND memory of another SSHD.

Also, the host device 10 may copy data read from magnetic disks (HDDs) of some arbitrary ones of the SSHDs to NAND memories of some arbitrary ones of the SSHDs.

Furthermore, the host device 10 reads out data from HDD #0 to HDD #P, subjects the data to some processing, and then writes the data to DRAM #0 to DRAM #5 at a very high speed. Thereafter, when the above data subjected to the processing is written to HDD #0 to HDD #P, a double-layered system of DRAMs and HDDs is achieved.

A concrete image of a storage system including SSHDs to which LEAs are allocated with Mode select/sense as shown in FIGS. 6-8 will be explained. It should be noted that the storage system includes five SSHDs, and the RAID levels of HDDs provided therein are RAID 4 or RAID 5. In a single SSHD, a DRAM has 256 MB, where 128 MB is used as an HDD internal table and cache data for HDD, and 128 MB is applied to a RAM disk for the host device 10. Furthermore, the NAND memory has 32 GB, where 4 GB is applied to an internal write cache for a magnetic disk (HDD), and 26 GB is applied to an SSD for the host device 10.

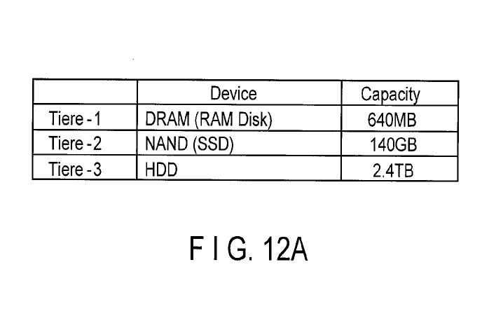

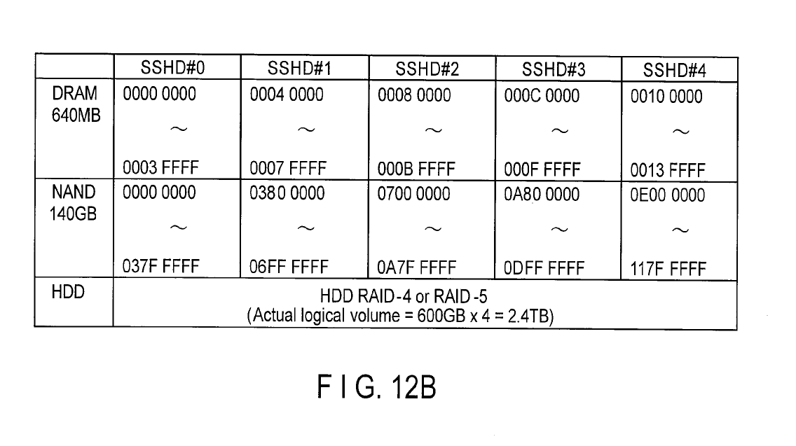

FIG. 12A shows a virtual device of a layered system and its capacities. A tier 1 is a RAM disk (DRAM) having 640 MB, a tier 2 is an SSD (NAND memory) having 140 GB, and a tier 3 is an HDD having 2.4 TB (=600 GB×4).

FIG. 12B shows allocation of LBA of five SSHD #0 to SSHD #5. In an SSHD #0, the LBA of a DRAM is 0000 0000 to 0003 FFFF, and that of a NAND memory is 0000 0000 to 037F FFFF. In an SSHD #1, the LBA of a DRAM is 0004 0000 to 0007 FFFF, and that of a NAND memory is 0380 0000 to 06FF FFFF. In an SSHD #2, the LBA of a DRAM is 0008 0000 to 000B FFFF, and that of a NAND memory is 0700 0000 to 0A7F FFFF. In an SSHD #3, the LBA of a DRAM is 000C 0000 to 000F FFFF, and that of a NAND memory is 0A80 0000 to ODFF FFFF. In an SSHD #4, the LBA of a DRAM is 0010 0000 to 0013 FFFF, and that of NAND memory is 0E00 0000 to 117F FFFF.

By virtue of the above structure, the host device 10 can obtain such a three-layer storage system which has capacities as shown in FIG. 12A.

As explained above, according to the embodiment, functions of a plurality of storage devices such as a magnetic disk (HDD), an SSD, and a RAM disk are obtained simply by providing a single storage device (SSHD) provided with a plurality of storage media such as a magnetic disk (HDD), a NAND memory and a DRAM. Thus, it is not necessary to provide a further slot or slots for an SSD, a RAM disk, etc., and it is possible to easily provide a layered structure simply by mounting the SSHDs according to the embodiment in place of conventional magnetic disks. Also, a magnetic disk space (HDD media space), a NAND memory space and a DRAM space in the SSHD can be data-accessed as separate devices by the host device, as a result of which they can be used, while maintaining structures of a host bus adapter and Expander of a system in which only conventional magnetic devices are mounted.

Although the interface module is a common one, the HDD media space, the NAND memory space and the DRAM space in the SSHD are controlled as separate address spaces, and functions are managed to be divided into functions of a plurality of storage media such as an HDD product, an SSD product and a RAM disk product. As a result, a two-layered structure/three-layered structure of a storage device can be achieved simply by applying only the SSHDs according to the embodiment.

Since part of the HDD media space is allocated to the NAND space or the DRAM space, a NAND area or a DRAM area can be allocated to a system cache or space corresponding to a high-ranked tier of a layered structure.

In the case where the NAND area or the DRAM area is allocated to a system cache or space corresponding to a high-ranked tier of a layered structure, a data synchronization function is applied to enable data to be copied between an internal HDD media space and NAND and DRAM spaces without data access from the host device, and achieve a high performance and a high efficiency of the system.

The various modules of the systems described herein can be implemented as software applications, hardware and/or software modules, or components on one or more computers, such as servers. While the various modules are illustrated separately, they may share some or all of the same underlying logic or code. The SCSI interface is explained by way of example; that is, the interface to be applied is not limited to the SCSI interface, and a SATA interface may be used. Also, although as the nonvolatile memory, the NAND memory is explained, the nonvolatile memory is not limited to the NAND memory, another nonvolatile memory may be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a magnetic disk;
a semiconductor memory used as a cache for the magnetic disk; and
an interface to a host device,
wherein the interface is configured to process address information from the host device as address information on the magnetic disk or address information on the semiconductor memory.

2. The storage device of claim 1, wherein the interface is configured to process the address information from the host device as the address information on the magnetic disk or the address information on the semiconductor memory in accordance with a value of a specific high-order byte of the address information from the host device.

3. The storage device of claim 1, wherein the interface is configured to process the address information from the host device as the address information on the magnetic disk or the address information on the semiconductor memory in accordance with a value of a specific bit of a read command or a write command including the address information from the host device.

4. The storage device of claim 1, wherein in accordance with a value of a specific bit of a read command or a write command including the address information from the host device, the interface is configured to access the magnetic disk or the semiconductor memory.

5. The storage device of claim 4, wherein the interface is configured to perform, in accordance with the value of the specific bit, any of writing to the magnetic disk, writing to the semiconductor memory, writing to the magnetic disk and the semiconductor memory, reading from the magnetic disk, reading from the semiconductor memory, and writing of data read out from the magnetic disk to the semiconductor memory.

6. The storage device of claim 1, wherein the interface is configured to perform allocation of an address space or copying of data between the magnetic disk and the semiconductor memory in accordance with a value of a specific bit of a predetermined command including the address information from the host device.

7. The storage device of claim 6, wherein the interface is configured to perform, in accordance with the value of the specific bit, any of allocation of a first address space of the magnetic disk to a second address space of the semiconductor memory, copying of data of the first address space to the second address space, allocation of a third address space of the semiconductor memory to a fourth address space of the magnetic disk, and copying of data of the third address space to the fourth address space.

8. A storage system comprising:
a host device; and
a plurality of storage devices each comprising a magnetic disk, a semiconductor memory which is used as a cache for the magnetic disk, and an interface to the host device,
wherein:
the interface is configured to process address information from the host device as address information of the magnetic disk or address information of the semiconductor memory; and
the interface is configured to access the magnetic disk or the semiconductor memory in accordance with an access frequency of data.

9. The storage system of claim 8, wherein the interface is configured to copy data of a specific area of the magnetic disk to the semiconductor memory.

10. The storage system of claim 8, wherein the host device is able to copy data of a magnetic disk of a first storage device included in a plurality of the storage devices to a semiconductor memory of a second storage device different from the first storage device, which is included in a plurality of the storage devices.

11. The storage system of claim 8, wherein the host device is able to copy data read out from magnetic disks of some storage devices included in a plurality of the storage devices to semiconductor memories of some storage devices included in a plurality of the storage devices.

12. A method of a storage device comprising a magnetic disk, a semiconductor memory used as a cache for the magnetic disk, and an interface to a host device, the method comprising:
processing address information from the host device as address information on the magnetic disk or address information on the semiconductor memory.

13. The method of claim 12, wherein the address information from the host device is regarded as the address information on the magnetic disk or the address information on the semiconductor memory in accordance with a value of a specific high-order byte of the address information from the host device.

14. The method of claim 12, wherein the address information from the host device is processed as the address information on the magnetic disk or the address information on the semiconductor memory in accordance with a value of a specific bit of a read or write command including the address information from the host device.

15. The method of claim 12, wherein the magnetic disk or the semiconductor memory is accessed in accordance with a value of a specific bit of a read command or write command including the address information from the host device.

16. The method of claim 15, wherein any of writing to the magnetic disk, writing to the semiconductor memory, writing to the magnetic disk and the semiconductor memory, reading from the magnetic disk, reading from the semiconductor memory, and writing of data read out from the magnetic disk to the semiconductor memory is performed in accordance with the value of the specific bit.

17. The method of claim 12, wherein allocation of an address space or copying of data between the magnetic disk and the semiconductor memory is performed in accordance with a value of a specific bit of a predetermined command including the address information from the host device.

18. The method of claim 17, wherein any of allocation of a first address space of the magnetic disk to a second address space of the semiconductor memory, copying of data of the first address space to the second address space, allocation of a third address space of the semiconductor memory to a fourth address space of the magnetic disk, and copying of data of the third address space to the fourth address space is performed in accordance with the value of the specific bit.
